(19) United States
(12) Patent Application Publication
(10) Pub. No.: US 2005/0171976 A1
(43) Pub. Date: Aug. 4, 2005

(54) Diagrammatic method and system to build repository queries

(75) Inventors: William John West, Langhorne, PA (US); Susan Heath, Washington Crossing, PA (US)

Correspondence Address: BAKER & MCKENZIE LLP, 805 THIRD AVENUE - 29TH FLOOR, NEW YORK, NY, 10022, US

(73) Assignee: Computer Associates Think, Inc., Islandia, NY (US)

(21) Appl. No.: 10/890,316

(22) Filed: Jul. 12, 2004

Related U.S. Application Data
(60) Provisional application No. 60/486,789, filed on Jul. 11, 2003.

(51) Int. Cl. G06F 17/00

(52) U.S. Cl. 707/104.1

(57) ABSTRACT

A diagrammatic system and method for building repository queries are provided. In one aspect, the system includes a user interface page having scripts. The user interface page includes diagram object with embedded script. The diagram objects includes an array of node lists. The diagram objects and nodes in the array may be selected or deselected by a user to identify a query. The scripts communicate to determine the selected objects. The selected objects are passed to a server for building the query and running the query against a repository to produce the query results.

### CROSS-REFERENCE TO RELATED APPLICATIONS

This application claims the benefit of U.S. Provisional Patent Application No. 60/486,789 entitled DIAGRAMMTIC METHODS TO BUILD REPOSITORY QUERIES filed on Jul. 11, 2003, the entire disclosure of which is incorporated herein by reference.

### TECHNICAL FIELD

This application relates generally to computer user interface systems, and more particularly to providing a diagrammatic user interface for navigating through metadata models to build queries against database systems.

### BACKGROUND

Many products display information in diagrammatic form including the node/arc type of diagram used in this instance. Most of these applications use a non-interactive display, and the majority of the remainder use user interaction to affect the display of the diagram itself, or to update the content of the document of which it is the displayable form.

### SUMMARY

Diagrammatic method and system to build repositories are provided. In one aspect, the method includes presenting a user interface page having one or more diagram objects that are selectable by a user and an array of node lists, each node in the array being selectable by a user. The selected objects are received and built into a repository query string, which query then may be run against a repository or a database to produce one or more query results.

In another aspect, the diagrammatic system to build repository queries includes a user interface page. The user interface page may be a World Wide Web page. One or more diagram objects are presented on the user interface page, the one or more diagram objects being selectable by a user, for example, by clicking on them. An array of node lists is presented in the one or more diagram objects. Each node in the array of node lists is selectable by a user, for example, by clicking on it. A module is operative to receive one or more diagram objects and one or more node lists in the array of node lists that a user selected. The module further is operative to build a query string using the selected one or more diagram objects and one or more node lists. The user interface page and the diagram objects may include scripts that function to determine and communicate the selected objects.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram illustrating the components of the system of the present disclosure in one embodiment.

FIG. 2 is a flow diagram illustrating a method of building repository queries in one embodiment.

FIG. 3 is a flow diagram illustrating a method of selecting paths in one embodiment.

FIG. 4 is a flow diagram illustrating a method of starting path in one embodiment of the present disclosure.

FIG. 5 is a flow diagram illustrating a method of traversing path in one embodiment of the present disclosure.

### DETAILED DESCRIPTION

The method and system of the present disclosure, in one embodiment, utilizes diagrams to perform user interface functions to achieve or effect a result. For example, users may click on diagrams to generate a query, which is run against a relational database to produce a result table.

As another example, repository documentation includes diagrams of the various sub-models of metadata from various sources. The method and system of the present disclosure, in one embodiment, allows these diagrams to become an active part of a users interface where users may navigate through the diagrams.

In one embodiment, SVG (scalable vector graphics) is used to create a user interface where the existing model diagrams are presented as clickable objects that allow the end user to select pathways through the entity/relationship hierarchy. Briefly, SVG is a W3C (World Wide Web Consortium standard body) standard for image processing in a World Wide Web document. The SVG specification is based on XML (extensible markup language), which also is a W3C standard. SVG is a text-based system and does not require special editors, although a browser plug-in is currently needed to render a picture. Rendering engine may become a standard part of future browsers.

In this instance, SVG also provides the capability for the customer to tailor the diagrams to match any extensions they may have made to the metadata model, without the repository providing the tool. Although SVG is used in this implementation to permit customer tailoring with a simple text editor, the method could also be used with any other scriptable diagram presentation, such as Macromedia Flash, for which a proprietary tool would be needed. A Java applet or other compiled object may also be substituted for SVG and achieve similar results, through use of an external tool, such as a compiler, to build the object.

In one embodiment, the method and system of the present disclosure present a diagram representing classes of metadata and their connecting associations and relationships, selecting a navigational start point—this selection may be previously performed and passed in to the process, selecting paths between connected items, and converting the start point and selected paths to a SQL (structured query language) query against an RDBMS (relational database management system). The method and system may also generalize these methods to multiple start points.

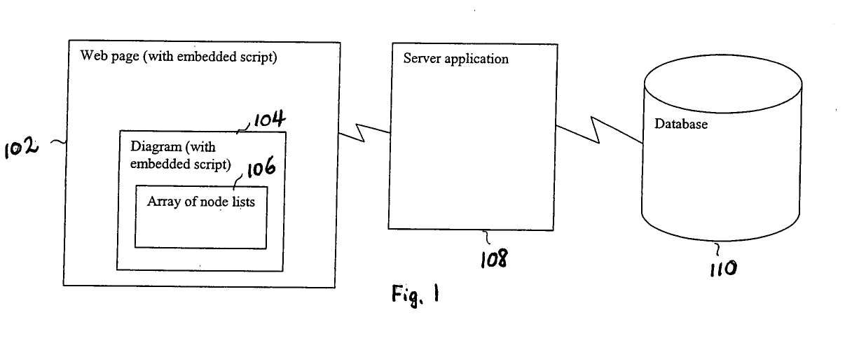

In one embodiment, a Web page may contain a SVG diagram and post an origin and list of paths to a server application, which then converts that information into an SQL query. FIG. 1 is a block diagram illustrating the components of the system of the present disclosure in one embodiment. A user interface such as a web page 102 includes one or more diagram objects 104. The web page 102 and the diagram objects 104 include embedded scripts.

The diagram object 104 contains an array of node lists 106 representing the paths that may be chosen. Each list in the array of node lists 106 has a selection indicator that is set if the path is selected. In one aspect, the nodes in the list are ordered and separate entries exist for each direction the path may be traversed. Selecting an origin point eliminates from consideration all paths not starting at that point, i.e., all lists not starting with the selected node. These will have their selection indicator set to “off” once the origin has been chosen. Thereafter, paths starting at the origin may be toggled on and off until the user is satisfied with the set chosen.

Although the method and system described is for a single start point and paths of a single “step” from that origin, the method and system may be generalized to the choice of multiple start points, and more than one “step” by repetition of those phases of the process. To achieve the transition between those phases, there may be an additional user input to switch from one to the other.

With a single origin, the transition is automatic as soon as an origin is selected. For example, a script in the Web page 102 may read the selected entries from the array 106 and post their node lists to the server application 108 for processing.

The method and system of the present disclosure may work independently of the specific diagram. For instance, a single web page can be used with a variety of diagram objects that implement the script functions. Such functions of the script may include setting the start point for the diagram if it is already known, tracking the progress of the path selection, and extracting the selected paths and submitting the query request when the user is ready to do so.

Requirements often dictate that the resulting query return the same common columns from each table processed. In this case the query built is an SQL UNION of the results from each individual path, and can be performed in a single request to the database. In another aspect, a general process component may perform multiple queries and aggregate the results before returning a document to the end user.

In one embodiment, the server application 108 knows the pre-existing relationships between the contents of the tables depicted in the diagram, and can use pre-coded predicates to construct the query or queries. The origin point may selected before or after presenting the web page that includes the diagram objects. Functions in the web page script and diagram script communicate the choice of origin point.

In one embodiment, the diagram objects may include selectable items that exist in up to four states: “focused”—i.e., the selected item is a start point, “selected”, “unselected”, and “unreachable”, meaning that there is no usable path from the start point to this item. Feedback to the user is provided in the diagram to indicate in which state each item currently exists.

The specific implementation scheme for this feedback may take many forms. For example, the feedback processing can be adapted to the user's requirements such as color blindness. These states are implicit in the stored origin and array of path data, and may be derived at any point from that data. Variations in the methods are possible that would evaluate and store the state separate from the source data (i.e. stored origin and paths), for performance reasons, without changing the overall process logic.

The server application 108 can be passed a list of paths which have a common start point, or this may be factored out and sent once only as a separate origin parameter. Depending on the nature of the desired result document, these paths may be processed sequentially, and a result document created by appending the results, or they may be used to build a single query. In addition, the start instance may be uniquely selected by additional key data.

The system of the present disclosure in one embodiment includes three basic components: a web page containing script 102; one or more diagram objects, for example SVG diagrams providing the path selection interface 104, and some server-based code 108 that processes the selected path information into a query against the repository data 110.

In one embodiment, the web page and its script 102 may be independent of the diagram being used. The web page script 102 handles interaction with the diagram's embedded script by using communication variables attached to the diagram object.

The variables passed into the diagram 104 are the stage of selection progress (i.e., has a start entity already been chosen) and the type of selected entity, if a choice does already exist. Output from the diagram 104 may be a list of selected paths from the selected entity. The script will also initiate a pop-up window for start point selection if required.

The page scripts 102, for example, web page scripts, set and retrieve the focus and paths properties of the diagram object. If the page is entered with a prior selection of entity type then the focus property will be set, otherwise it will be null. The paths array may be read when the user signals completion of their selection, and each selected path may be passed to the server logic for processing. Each paths entry may be a list including a selection flag, followed by a variable number of nodes. The node data may be passed to the server 108.

The results of the user selection may be passed to the server via HTTP POST to form an external interface to other modules. One or more instances of path=“node,node, . . . ” may comprise the body of the request.

In one embodiment, the script contained in the diagram 104 provides the visual feedback to the user on the progress of the selection of the start entity and paths, for example, for the impact analysis. If the start point is passed in, or after the user clicks a diagram box to select one, the node may be highlighted, and the available paths from it are pre-selected to indicate what is possible. The user then de-selects any paths not to be used. This method, thus, in one embodiment, makes a default choice of all paths. In another embodiment, if this is not desirable, highlighting may distinguish three states instead of two, that is, an additional “available” state may be provided. Thus, in this embodiment, the states of path may include “on” for selected path, “off” for not selected path, and “available” for paths that may be selected or not selected. The owning HTML page's script 102 can read out the list of paths selected. The selection of an initial entity-type may be communicated to the outside script by setting a variable.

An SVG diagram may be created to correspond to each DIALOG of the ISPF-based interface existing today. Briefly, ISPF refers to the user interface software used by TSO on the mainfram/3270 implementation of Advantage Repository. TSO refers to Time Sharing Option, a platform software for multi-user execution of the mainframe Advantage Repository code. The SVG diagrams could closely match those printed in the reference guide for the metadata models. In another aspect, the document can be changed to match the SVG if appropriate.

In one embodiment, in implementing the diagrams 104, the internal script functions of the diagram scripts may be identical in all diagrams. The variable content can comprise the path list, and the actual visual content. The naming convention that may be used in the identifiers is to prefix the repository entity id with E for an Entity, R for a Relationship and L for a link, which may be an Association or part of a Relationship. This convention allows the server logic to process the path data, as well as assisting the script logic.

The diagrams' 104 external interfaces to other modules include allowing the web page script access to the focus and paths properties of the diagram.

The focus property may be read-write and holds the identifier of the selected start entity for the paths used. The paths property may be an array of lists of nodes, with the first element of each list being an indicator of the selection state of the path.

In the server side, the web page 102 will pass the raw path list to the server 108, and the SQL for retrieval of the result set will be generated there, in one embodiment. This will in general be a UNION of the sub-queries selecting the end-point from the repository XREF table 110, given the start-point and link, and then JOINing to the target table to retrieve the name, version and status.

The query string so built may be passed to a common routine for creating a result set. The process that allows the selection of the start point can also call the same query processor. The function of the common routing or the query processor may be executing the query string against the database 110. The query in this case may be a simpler one accessing a single table with criteria based on the name version and status columns only.

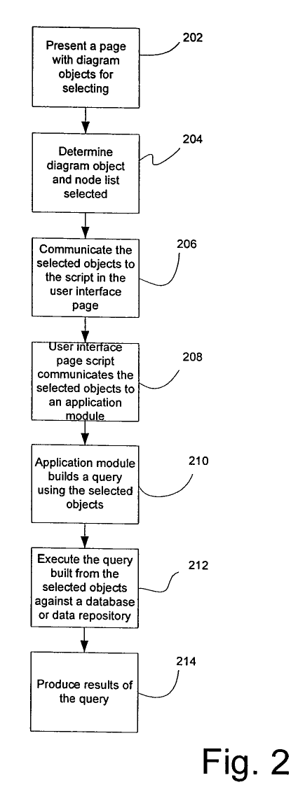

FIG. 2 is a flow diagram illustrating a diagrammatic method of building repository queries in one embodiment. AT 202, a page such as a web page is presented to a user. The page contains diagram objects such as the SVG diagrams, which a user may click on to select the objects. At 204, objects selected are determined. This determination may be made in one embodiment, by a script that is embedded in the diagram object and that receives a signal when a user selects the diagram object. The selected objects are then communicated to a module that uses these objects to build repository queries. For example, at 206, the diagram object script communicates the selected object to the web page, for example, to a script that is embedded in the web page. At 208, the web page script in turn communicates the selected objects to a module that will use the objects to build repository queries. At 210, the built queries are executed against a database or data repository. At 212, the results of the queries are produced, for example, in a document. The page may be any user interface page that is capable of presenting selectable diagram objects to a user, and need not be limited to a web page. Further, the communicating of the selected objects need not be performed through the diagram's embedded script and the page script specifically, but may be communicated using any other methods capable of communicating data. In addition, the functions of the page script and the diagram's embedded script may be consolidated such that a general module may be used instead to perform the similar functions.

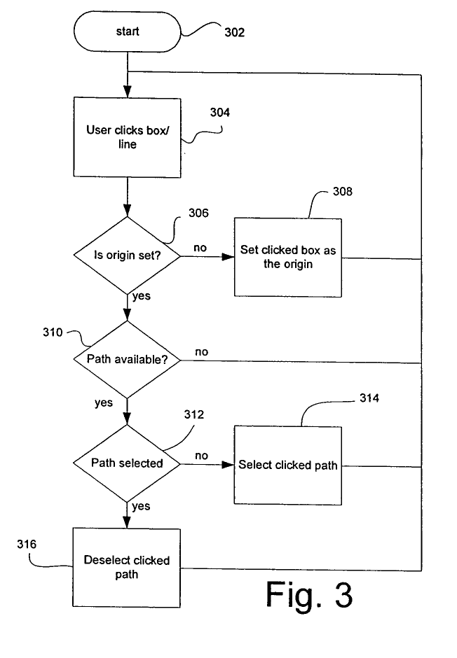

FIG. 3 is a flow diagram illustrating a method of selecting path in one embodiment. At 302, a user clicks on a diagram object. As described above, the diagram object may be presented as part of a web page, or any other interface page. At 304, if origin is set, the method proceeds to 308. If the origin is not set, at 306, the clicked object is set as the origin.

At 308, if path is available, a path is selected at 310. If path is not available, no action is taken. At 310, if path is selected, the path may be deselected at 314. If path is not selected, at 312, path is clicked to select it.

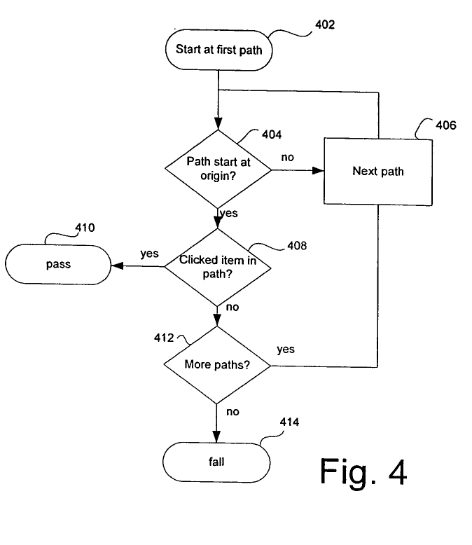

FIG. 4 is a flow diagram illustrating a method of starting path in one embodiment of the present disclosure. At 402, first path is started. At 404, it is determined whether path starts at origin. At 406, if path does not start at origin, next path is processed. At 408, it is determined if a user clicked item in path. If yes, at 410, the method passes. If no, at 412, more path is tested. At 414, if there are no more path, the method falls.

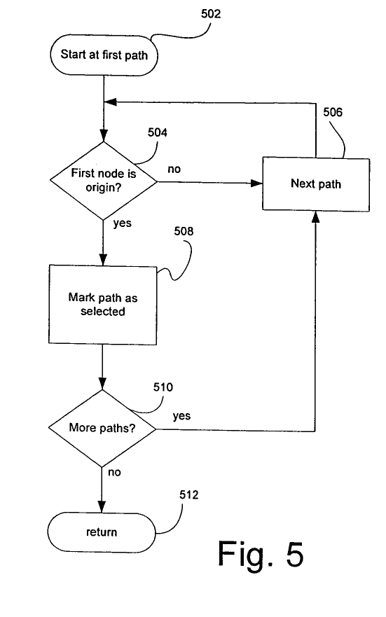

FIG. 5 is a flow diagram illustrating a method of traversing path in one embodiment of the present disclosure. At 502, path is started. At 504, it is determined whether first node is origin. If no, next path is processed at 506. At 508, path is marked as selected. At 510, if there are more paths, the method processes next path at 506. If there are no more path, the method returns at 512.

The system and method of the present disclosure may be implemented and run on a general-purpose computer. For example, the system and method may be implemented as set of computer instructions to be stored on computer memory units and executed on the computer processor. The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A diagrammatic system for building repository queries, comprising:
a user interface page;
one or more diagram objects presented on the user interface page, the one or more diagram objects selectable by a user;
an array of node lists presented in the one or more diagram objects, the array of node lists selectable by a user;
an application module operative to receive selected one or more diagram objects and one or more node lists in the array of node lists, the module further operative to build a query string using the selected one or more diagram objects and one or more node lists.

2. The system of claim 1, further including:
a query module operative to receive the query string and run the query string against a repository.

3. The system of claim 1, further including:
producing one or more results from executing the query string against a repository.

4. The system of claim 1, wherein the user interface is a web page.

5. The system of claim 1, further including:
a first script embedded in the user interface page, the first script operative to receive the selected one or more diagram objects and one or more node lists and communicate the selected one or more diagram objects and one or more node lists to the application module.

6. The system of claim 5, further including:
a second script embedded in the one or more diagram objects, the second script operative to determine the selected one or more diagram objects and one or more node lists when a user clicks on one or more diagram objects and one or more node lists, the second script further operative to have the selected one or more diagram objects and one or more node lists available to the first script.

7. The system of claim 1, wherein the one or more diagrammatic objects include an origin point.

8. The system of claim 7, wherein the array of node lists includes one or more path from the origin point.

9. The system of claim 8, wherein the one or more path may be selected, or deselected, or selected and deselected.

10. The system of claim 1, wherein the one or more diagrammatic objects include a plurality of origin points.

11. The system of claim 10, wherein the array of node lists include a plurality of paths originating from the plurality of origin points.

12. A diagrammatic method of building repository queries, comprising:
presenting a user interface page having one or more diagram objects that are selectable by a user and an array of node lists, each node in the array being selectable by a user;
receiving one or more selected diagram objects;
receiving one or more selected nodes; and
building a repository query according to the one or more selected diagram objects and the one or more selected nodes.

13. The method of claim 12, further including:
executing the repository query against a repository.

14. The method of claim 13, further including:
producing one or more results to the repository query.

15. The method of claim 12, further including:
embedding a script in the one or more diagram objects to determine whether the one or more diagram objects are selected.

16. A program storage device readable by a machine, tangibly embodying a program of instructions executable by the machine to perform a diagrammatic method of building repository queries, comprising:
presenting a user interface page having one or more diagram objects that are selectable by a user and an array of node lists, each node in the array being selectable by a user;
receiving one or more selected diagram objects;
receiving one or more selected nodes; and
building a repository query according to the one or more selected diagram objects and the one or more selected nodes.
